(19) United States
(12) Patent Application Publication
(10) Pub. No.: US 2019/0122139 A1
(43) Pub. Date: Apr. 25, 2019

(54) SYSTEM AND METHOD FOR GENERATING SQL SUPPORT FOR TREE ENSEMBLE CLASSIFIERS

(71) Applicant: PAYPAL, INC., San Jose, CA (US)

(72) Inventor: Omri Perez, Ramat Hashahron (IL)

(21) Appl. No.: 15/788,795

(22) Filed: Oct. 19, 2017

(51) Int. Cl. G06N 99/00; G06N 5/04; G06F 17/30

(52) U.S. Cl. CPC G06N 99/005; G06F 17/30427; G06F 17/30961; G06N 5/045

(57) ABSTRACT

Aspects of the present disclosure involve systems, methods, devices, and the like for generating SQL support for tree ensemble classifiers applicable to machine learning. In one embodiment, a system is introduced that can translate a machine learning model into and SQL query for running the model in legible SQL code. The machine learning model can include a regression and classification model such as a gradient boosting model and/or random forest model.

### TECHNICAL FIELD

The present disclosure generally relates to machine learning in communication devices, and more specifically, to generating SQL support for tree ensemble classifiers applicable to machine learning in communication devices.

### BACKGROUND

Nowadays with the evolution and proliferation of electronics, information is constantly being collected and processed. Modern servers offer a robust, easy, and performant way of analyzing these large quantities of data collect. A common need in organizations is to periodically classify, predict, and label many of the records generated from the data collected. In some instances, the records/data can become so large that traditional data processing applications may be inadequate for such processing and analyzing. As such, academia and industry have developed numerous techniques for analyzing the data including machine learning, AB testing, and natural language processing. Machine learning in particular, has received a lot of attention due to its ability to learn and recognize patterns using algorithms that can learn from and make predictions from the data. However, most modern servers do not offer machine learning capabilities that would enable the data to be adequately processed. Thus, it would be beneficial to create a system that can enable machine learning capabilities on a system such as an SQL server.

### BRIEF DESCRIPTION OF THE FIGURES

FIG. 1 illustrates a flowchart for SQL support in tree ensemble classifiers.

FIG. 2 illustrates a decision tree structure applicable to machine learning.

FIG. 3 illustrates a gradient boosting tree boosting structure applicable to machine learning.

FIG. 4 illustrates a flow diagram illustrating operations for generating SQL support for tree ensemble classifiers.

FIGS. 5A-5B illustrate sample runs in production for generating SQL support for tree ensemble classifiers.

FIG. 6 illustrates a block diagram of a system for generating SQL support for tree ensemble classifiers.

FIG. 7 illustrates an example block diagram of a computer system suitable for implementing one or more devices of the communication systems of FIGS. 1-5.

Embodiments of the present disclosure and their advantages are best understood by referring to the detailed description that follows. It should be appreciated that like reference numerals are used to identify like elements illustrated in one or more of the figures, whereas showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Aspects of the present disclosure involve systems, methods, devices, and the like for generating SQL support for tree ensemble classifiers applicable to machine learning. In one embodiment, a system is introduced that can translate a machine learning model into an SQL query for running the model in legible SQL code. The machine learning model can include a regression and classification model such as a gradient boosting model and/or random forest model.

Machine learning is a collection of tools and techniques that have gained popularity in the big data space for its capacity to process and analyze large amounts of data. In particular, machine learning has grown in popularity due to its ability to learn and recognize patterns found in the data. Various algorithms exist that may be used for learning and predicting in machine learning. The algorithms may include, but are not limited to support vector machines, artificial neural networks, Bayesian networks, decision tree learning, etc. Decision tree learning is one commonly used algorithm that uses decision trees to map observations, decisions, and outcomes. In some instances, numerous decision trees can be used in serial or parallel to process such information.

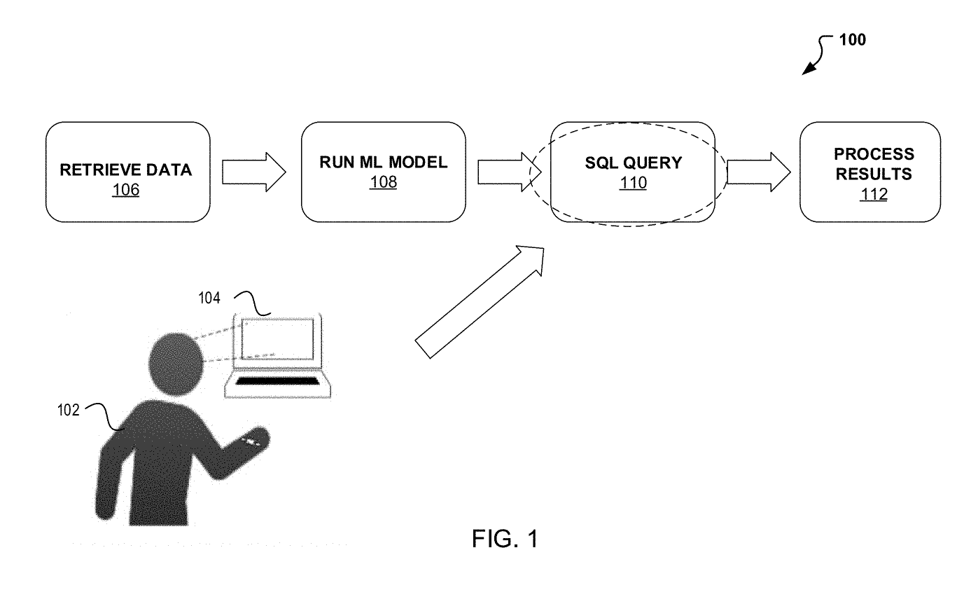

Conventional systems however, are currently not integrated in such a way that enable the machine learning model to work in production without the need for human intervention. Instead, as illustrated in FIG. 1, when a periodic classification or prediction is needed user 102 interactions with the SQL server over device 104 to enable such prediction and/or classification. Therefore, it would be beneficial to introduce a system and method that enables the automatic use and prediction of the machine learning model.

FIG. 1 is introduced which illustrates a flowchart for SQL support in machine learning model. In one embodiment, a system 100 is introduced which enables the translation of the machine learning model into an SQL Query such that the model may be run with the SQL servers for data prediction and classification without human intervention. As illustrated in FIG. 1, generally data classification and prediction begins with the retrieval of the data 106 for processing. The data may derive from one or more servers within a pool or group of pools distributed across various geographical locations or the like. The data retrieved, can then be run though a machine learning model 108 for making a prediction and/or classification. After the model is run, in a conventional system, user 102 would interact with device 104 for use in production. In this instead, SQL query 110 is introduced which enables the translation for use of the machine learning model. Therefore, the SQL Query 110 may be run on the database/server during production and results may be processed 112.

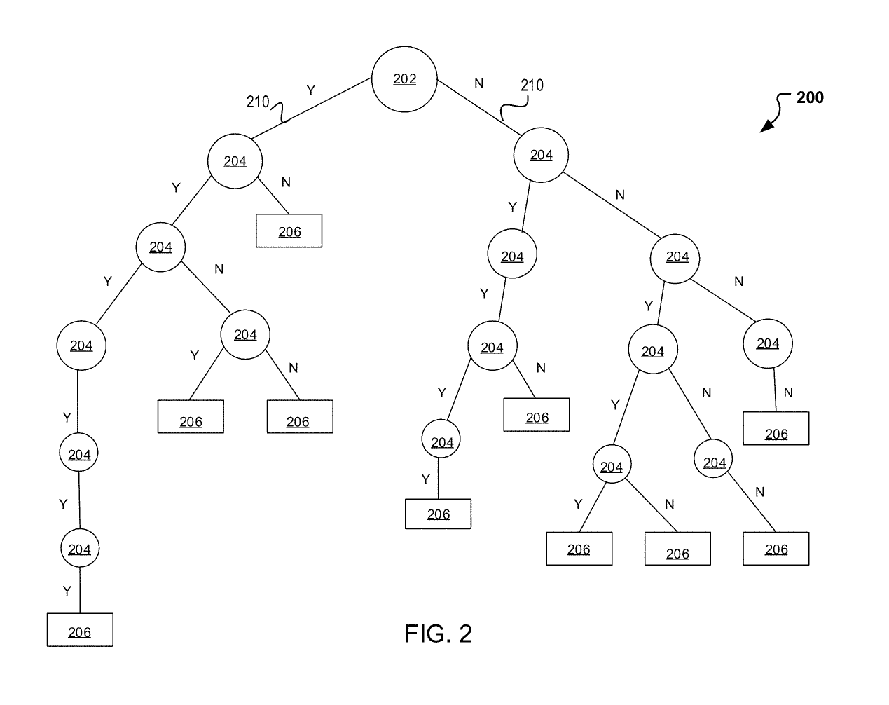

As indicated, various machine learning models exist for use in making predictions and/or classifications. For exemplary purposes, decision trees are used in this model for their ease of use. FIG. 2 illustrates a decision tree structure applicable to machine learning. In particular, FIG. 2 provides an exemplary decision tree 200 illustrating the mapping of relationships and observations to arrive at a conclusion(s). Generally, decision trees can be described in terms of three components, a root node, leaves, and branches. The root node can be the starting point of the tree. As illustrated in FIG. 2 this can include root 202, the top most node which indicates the start of the decision tree. In most instances, the root 202 may be used to indicate the main idea or main criteria that should be met to arrive at a decision.

Next, once the main criteria or root 202 has been established, branches extended from root node 202 can be used to indicate the various options available from the root 202. For example, the root may include a criteria which can have one of two outcomes which can be answered by a “yes” or “no.” FIG. 2, illustrates such example, where the root 202 provides two possible options indicated by the two branches 210 extending from the root 202. The branches can then attach to other (child) nodes 204 which are related to the root 202. Again branches 210 may then be extended from each node as more decisions (e.g. nodes 204) and possible outcomes (e.g., branches 210) exist. The decision tree 200 may continue to grow as more and more decisions are made until a final outcome is reached and represented by a leaf/label 206. As illustrated in FIG. 2, one or more leafs 206 are possible from a single node and in some instances, the leafs 206 may appear as early as the second node 204, while in other instances, the nodes 204 may extend several layers before arriving at a leaf 206.

As illustrated, the decision tree 200 may grow and can extend significantly as more data is received and decisions are to be made. FIG. 2 is for illustrative purposes only and more or less nodes, branches, and leaves may be added. In addition, FIG. 2 is designed to illustrate the intricacies of a decision tree and how quickly, the tree may become large. Further, FIG. 2 illustrates how the decision tree may arrive at a leaf/label 206 right away of after several iterations. In some instances, the decision reached may be incorrect and the model may need to be trained further to achieve competent results.

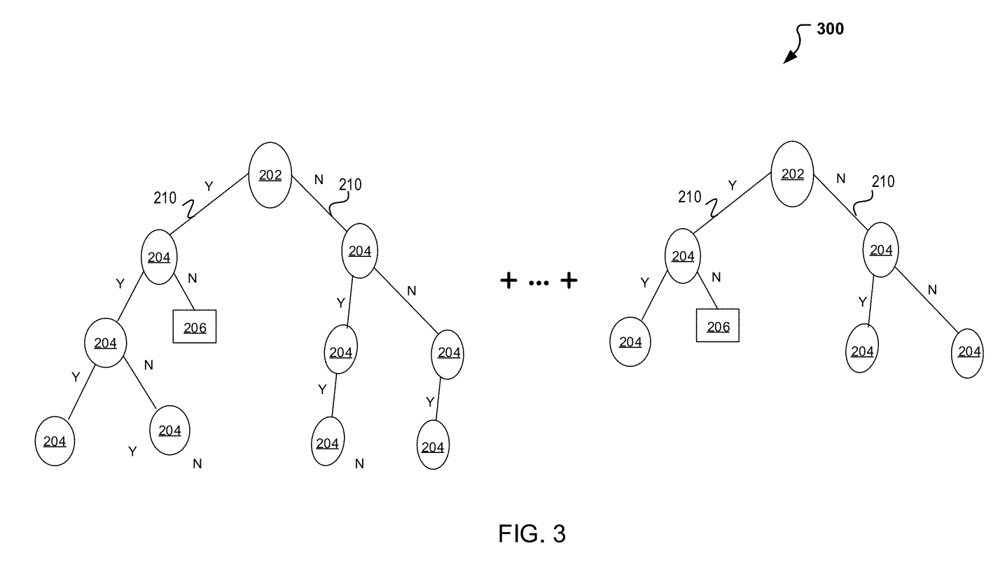

In machine learning, regression techniques exist which can be used to provide a prediction using an ensemble of weak prediction models (e.g., single decision tree). Thus, in line with the knowledge that decision trees may provide weak predictions, the use of decision tree ensembles is introduced. In particular the use of gradient boosting trees (GBT) and Random Forest (RF) techniques are introduced. FIG. 3 for example, illustrates a gradient boosting tree boosting structure applicable to machine learning. Gradient boosting trees is a machine learning technique that uses regression for classification and prediction. Therefore, instead of training one decision tree, it trains a group of ensemble of trees 300.

A GBT works in a serial manner such that a first decision tree is trained and a target is obtained. When the decision tree is trained however, it is recognized that the prediction is weak and/or errors may exist. Therefore, the model can take the error encountered and used the data to train another decision tree based on the error. The process continues and in some instances, a chart may be generated which graphs the errors until the error graph flattens out or converges. The chart can include a bar chart, a line graph, a statistical plot (e.g., bell shaped curve) or the like, where the errors are mapped. This process may continue for many iterations. In some instances, a theoretical limit can be set (e.g., 200 iterations) on the number of iterations (or trees processed) in order to avoid overfitting the system.

Note that this training model and system may be used with numerous machine learning applications where large data predictions and classifications may exist. As an example, consider an instance where a prediction is needed regarding the risk associated with a seller having limited or no prior transaction history. To make a prediction, information known about the seller (e.g., buyers associated with the seller) may be used to help make a determination as to whether or not open an account, complete a transaction, provide credit, etc. to the seller. Thus, the first decision tree may be used to classify the buyer into a good or bad category. These categories and corresponding buyers can be analyzed and a determination can be made regarding the errors made and location where they occurred. Thus, a second decision tree may be trained to try and “fix” the mistakes. A third decision tree then continues by focusing on any errors on the second decision tree. The process continues until model converges.

Note that other predictions may be made including determining account take over and the like. In addition, other prediction models may also be used. For example, a Random Forest (RF) model may be used. Like GBT, RF also uses prediction and classification; however, the decision trees are run in parallel with sampled data used in the training. In particular, Random Forest may use an ensemble of classification decision tree when performing classification and an ensemble of regression tree when performing regression.

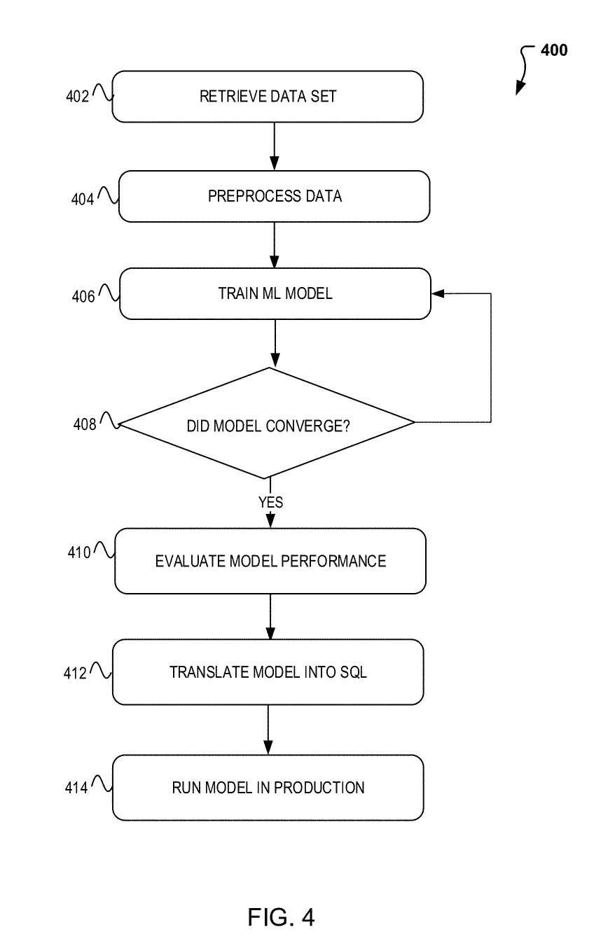

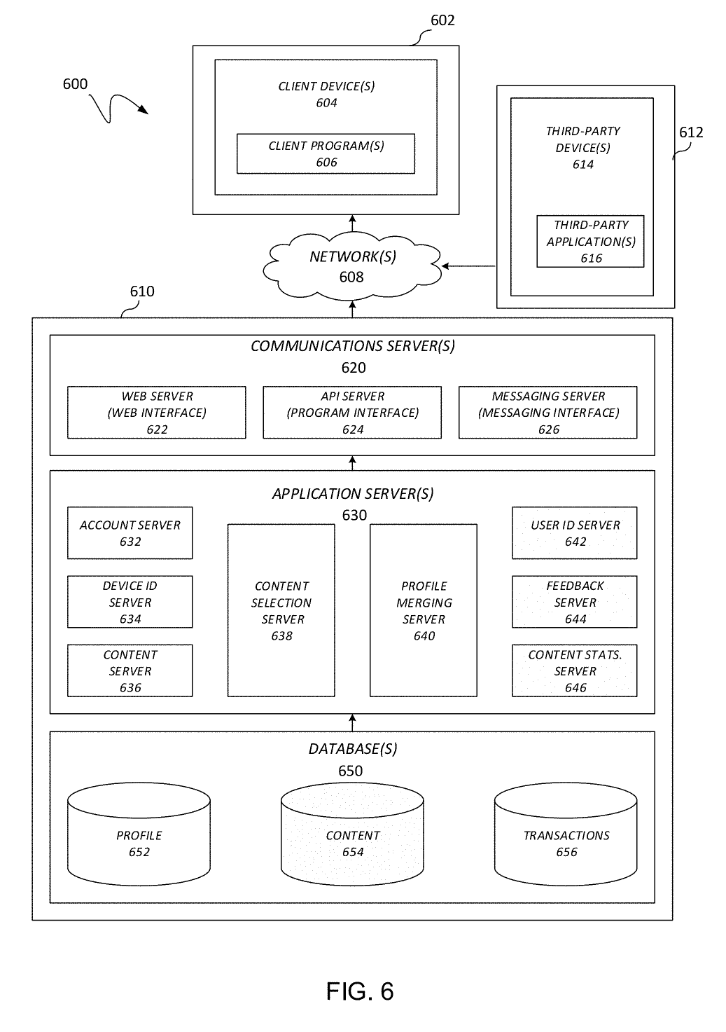

To illustrate how the machine learning models as described above and in conjunction with FIGS. 2-3, may be integrated into the system using an SQL query for generating SQL support for tree ensemble classifiers, FIG. 4 is introduced which illustrates example process 400 that may be implemented on a system, such as system 600 in FIG. 6. In particular, FIG. 4 illustrates a flow diagram illustrating how to generate and use an SQL query to translate a machine learning model for use in production. According to some embodiments, process 400 may include one or more of operations 402-414, which may be implemented, at least in part, in the form of executable code stored on a non-transitory, tangible, machine readable media that, when run on one or more hardware processors, may cause a system to perform one or more of the operations 402-414.

Process 400 may begin with operation 402, where data is retrieved. The data retrieved may come in the form of a user data set, user transaction information, account information, buyer information, seller information, etc. In some instances, the data retrieved is historical data, while in other instances, the data may be current. Following retrieval of the data, the data retrieved may then be preprocessed at operation 404. Preprocessing of the data may include formatting or organizing the data in such a way that it may be input into a machine learning model for analysis and prediction.

Once the data has been preprocessed, process 400 continues to train the machine learning model used for processing the data and making predictions. As previously indicated, large data is constantly collected by devices that oftentimes needs to be organized and analyzed. Such data can include the preprocessed data for training and using with the machine learning model. Oftentimes, the large data is organized using decision tree structures which can be used by the machine learning algorithms to extract the information of interest. In one embodiment, the decision tree structures may be used in training the machine learning model. As indicated, machine learning techniques using decision tree ensembles may be used. Decision tree ensembles such as Gradient Boosting Trees and Random Forest may be used for such regression and classification problems and predictions. As such, at operation 408, a decision is made as to whether the model has converged.

If the model has not yet converged, then process 400 returns to operation 406 for further training (e.g., further processing of additional decision trees). Alternatively, if the model is trained, the model continues to operation 410 for evaluation. Training model evaluation may include a comparison of known labels or results with those output by the model. In other words, a data set may be input into the trained model and its result compared to a known label or result for accuracy.

Once the model is fully trained and working properly, the model is ready for placement into production. To add the model into production, in a first embodiment, an SQL query is introduced which to enables the use of the machine learning model by translating the model into SQL query so that the model may be used in production for calculating and making predictions. In one embodiment, a python library is implemented to convert the machine learning model to legible SQL. For example, in order to run arbitrary Python code on Teradata, a python library may be implemented to convert a GBT and/or Random Forest model to legible SQL code. Therefore, process 400 continues to operation 412 where the model is translated for use with SQL. Process 400 then concludes with the run of the now integrated ML model in production at operation 414.

Note that although process 400 specifies the use of an SQL query and/or SQL code, the query and/or translation of the ML model may come in other forms. In addition, although GBT and RF are used as the machine learning models, note that the system is not so restricted and other machine learning techniques may be used and contemplated.

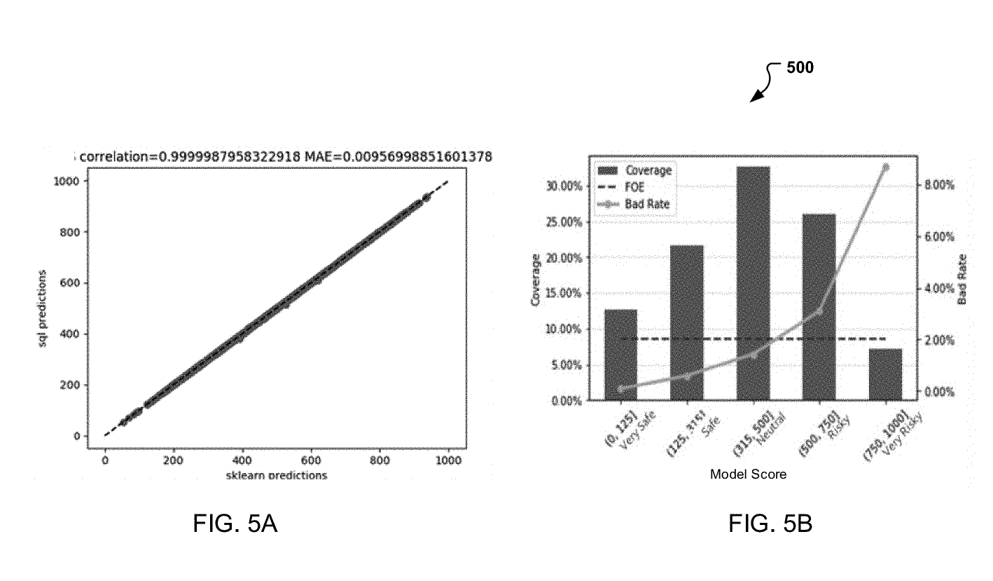

In order to ensure that process 400 was successfully implemented, a sample run production is presented in FIGS. 5A-5B. In particular, a validation run was performed, with FIG. 5A illustrating the accuracy of the model by presenting that the SQL model and the original python model achieved results that are closely correlated. As illustrated, the SQL model predictions are correlated to the python model prediction with correlation=99.99%.

Therefore, process 400 may be successfully implemented to run various data collection analytics. As an example, process 400 can be implemented to provide an indication of the risk involved with a new individual selling on a site provided that only minimal information is known about the seller. The information may be limited if the seller is fairly new to the system and/or is a casual buyer where sales are not habitual. In this example, process 400 can be implemented to collect information about the buyer provide a prediction as to the risk associated with the seller. The seller can be provided a code indicating the risk. FIG. 5B illustrates such use of the model where a seller is assessed and scored. Note that other analysis and predictions are possible using process 400. As an example, payment flows used, bank account information, and seller information may be used.

Note that additional parameters and uses are further available for use with the SQL and Table 1 and FIG. 5B for illustration purposes. Further, process 400 may be implemented using one or more systems. Therefore, where applicable, various embodiments provided by the present disclosure may be implemented using hardware, software, or combinations of hardware and software. For example, FIG. 6 illustrates, in block diagram format, an example embodiment of a computing environment adapted for implementing a system for generating SQL support for tree ensemble classifiers. As shown, a computing environment 600 may comprise or implement a plurality of servers and/or software components that operate to perform various methodologies in accordance with the described embodiments. Severs may include, for example, stand-alone and enterprise-class servers operating a server operating system (OS) such as a MICROSOFT® OS, a UNIX® OS, a LINUX® OS, or other suitable server-based OS. It may be appreciated that the servers illustrated in FIG. 6 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing environment 600 may include, among various devices, servers, databases and other elements, one or more clients 602 that may comprise or employ one or more client devices 604, such as a laptop, a mobile computing device, a tablet, a PC, a wearable device, desktop and/or any other computing device having computing and/or communications capabilities in accordance with the described embodiments. Client devices 604 may include a cellular telephone, smart phone, electronic wearable device (e.g., smart watch, virtual reality headset), or other similar mobile devices that a user may carry on or about his or her person and access readily. Alternatively, client device 604 can include one or more machines processing, authorizing, and performing transactions that may be monitored.

Client devices 604 generally may provide one or more client programs 606, such as system programs and application programs to perform various computing and/or communications operations. Some example system programs may include, without limitation, an operating system (e.g., MICROSOFT® OS, UNIX® OS, LINUX® OS, Symbian OSTM, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Some example application programs may include, without limitation, a web browser application, messaging applications (e.g., e-mail, IM, SMS, MIMS, telephone, voicemail, VoIP, video messaging, interne relay chat (IRC)), contacts application, calendar application, electronic document application, database application, media application (e.g., music, video, television), location-based services (LBS) applications (e.g., GPS, mapping, directions, positioning systems, geolocation, point-of-interest, locator) that may utilize hardware components such as an antenna, and so forth. One or more of client programs 606 may display various graphical user interfaces (GUIs) to present information to and/or receive information from one or more users of client devices 604. In some embodiments, client programs 606 may include one or more applications configured to conduct some or all of the functionalities and/or processes discussed below.

As shown, client devices 604 may be communicatively coupled via one or more networks 608 to a network-based system 610. Network-based system 610 may be structured, arranged, and/or configured to allow client 602 to establish one or more communications sessions between network-based system 610 and various computing devices 604 and/or client programs 606. Accordingly, a communications session between client devices 604 and network-based system 610 may involve the unidirectional and/or bidirectional exchange of information and may occur over one or more types of networks 608 depending on the mode of communication. While the embodiment of FIG. 6 illustrates a computing environment 600 deployed in a client-server operating relationship, it is to be understood that other suitable operating environments, relationships, and/or architectures may be used in accordance with the described embodiments.

Data communications between client devices 604 and the network-based system 610 may be sent and received over one or more networks 608 such as the Internet, a WAN, a WWAN, a WLAN, a mobile telephone network, a landline telephone network, personal area network, as well as other suitable networks. For example, client devices 604 may communicate with network-based system 610 over the Internet or other suitable WAN by sending and or receiving information via interaction with a web site, e-mail, IM session, and/or video messaging session. Any of a wide variety of suitable communication types between client devices 604 and system 610 may take place, as will be readily appreciated. In particular, wireless communications of any suitable form may take place between client device 604 and system 610, such as that which often occurs in the case of mobile phones or other personal and/or mobile devices.

In various embodiments, computing environment 600 may include, among other elements, a third party 612, which may comprise or employ third-party devices 614 hosting third-party applications 616. In various implementations, third-party devices 614 and/or third-party applications 616 may host applications associated with or employed by a third party 612. For example, third-party devices 614 and/or third-party applications 616 may enable network-based system 610 to provide client 602 and/or system 610 with additional services and/or information, such as merchant information, data communications, payment services, security functions, customer support, and/or other services, some of which will be discussed in greater detail below. Third-party devices 614 and/or third-party applications 616 may also provide system 610 and/or client 602 with other information and/or services, such as email services and/or information, property transfer and/or handling, purchase services and/or information, and/or other online services and/or information and other processes and/or services that may be processes and monitored by system 610.

In one embodiment, third-party devices 614 may include one or more servers, such as a transaction server that manages and archives transactions. In some embodiments, the third-party devices may include a purchase database that can provide information regarding purchases of different items and/or products. In yet another embodiment, third-party severs 614 may include one or more servers for aggregating consumer data, purchase data, and other statistics.

Network-based system 610 may comprise one or more communications servers 620 to provide suitable interfaces that enable communication using various modes of communication and/or via one or more networks 608. Communications servers 620 may include a web server 622, an API server 624, and/or a messaging server 626 to provide interfaces to one or more application servers 630. Application servers 630 of network-based system 610 may be structured, arranged, and/or configured to provide various online services, merchant identification services, merchant information services, purchasing services, monetary transfers, checkout processing, data gathering, data analysis, and other services to users that access network-based system 610. In various embodiments, client devices 604 and/or third-party devices 614 may communicate with application servers 630 of network-based system 610 via one or more of a web interface provided by web server 622, a programmatic interface provided by API server 624, and/or a messaging interface provided by messaging server 626. It may be appreciated that web server 622, API server 624, and messaging server 626 may be structured, arranged, and/or configured to communicate with various types of client devices 604, third-party devices 614, third-party applications 616, and/or client programs 606 and may interoperate with each other in some implementations.

Web server 622 may be arranged to communicate with web clients and/or applications such as a web browser, web browser toolbar, desktop widget, mobile widget, web-based application, web-based interpreter, virtual machine, mobile applications, and so forth. API server 624 may be arranged to communicate with various client programs 606 and/or a third-party application 616 comprising an implementation of API for network-based system 610. Messaging server 626 may be arranged to communicate with various messaging clients and/or applications such as e-mail, IM, SMS, MMS, telephone, VoIP, video messaging, IRC, and so forth, and messaging server 626 may provide a messaging interface to enable access by client 602 and/or third party 612 to the various services and functions provided by application servers 630.

Application servers 630 of network-based system 610 may be a server that provides various services to clients including, but not limited to, data analysis, geofence management, order processing, checkout processing, and/or the like. Application server 630 of network-based system 610 may provide services to a third party merchants such as real time consumer metric visualizations, real time purchase information, and/or the like. Application servers 630 may include an account server 632, device identification server 634, payment server 636, queue analysis server 638, purchase analysis server 640, user ID server 642, feedback server 644, and/or content statistics server 646. These servers, which may be in addition to other servers, may be structured and arranged to configure the system for monitoring queues as well as running and storing learning information for the decision ensemble tree processing.

Application servers 630, in turn, may be coupled to and capable of accessing one or more databases 650 including a profile database 652, content database 654, transactions database 656, and/or the like. Databases 650 generally may store and maintain various types of information for use by application servers 630 and may comprise or be implemented by various types of computer storage devices (e.g., servers, memory) and/or database structures (e.g., relational, object-oriented, hierarchical, dimensional, network) in accordance with the described embodiments.

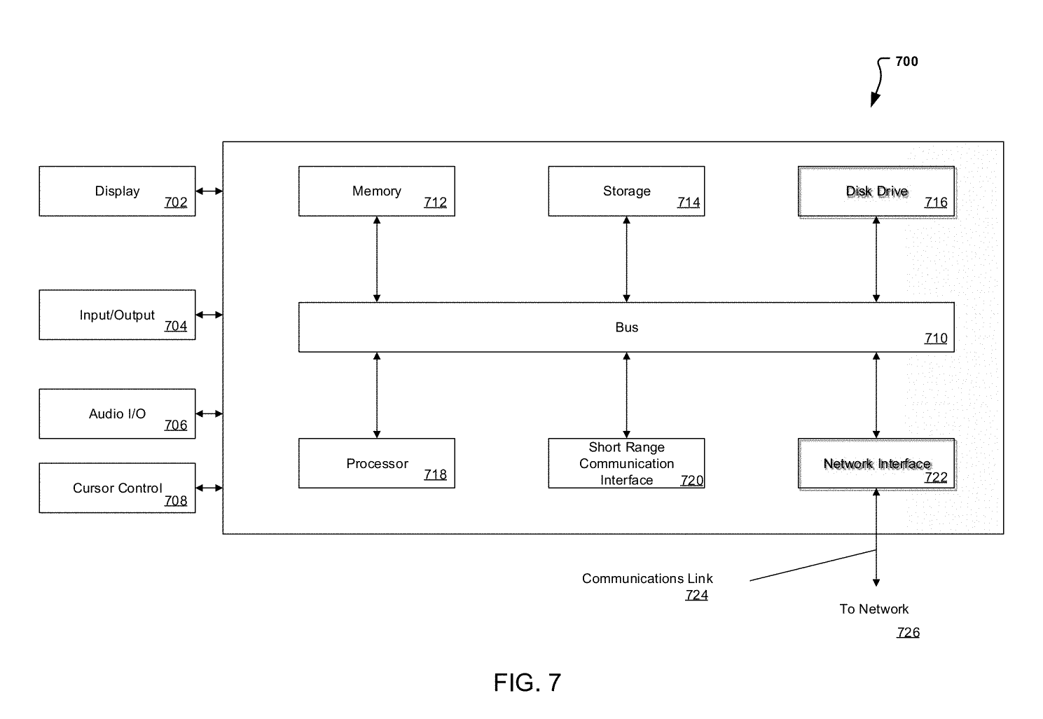

FIG. 7 illustrates an example computer system 700 in block diagram format suitable for implementing on one or more devices of the system in FIGS. 1-6. In various implementations, a device that includes computer system 700 may comprise a personal computing device (e.g., a smart or mobile device, a computing tablet, a personal computer, laptop, wearable device, PDA, server system, etc.) that is capable of communicating with a network 726. A service provider and/or a content provider may utilize a network computing device (e.g., a network server) capable of communicating with the network. It should be appreciated that each of the devices utilized by users, service providers, and content providers may be implemented as computer system 700 in a manner as follows.

Additionally, as more and more devices become communication capable, such as new smart devices using wireless communication to report, track, message, relay information and so forth, these devices may be part of computer system 700. For example, windows, walls, and other objects may double as touch screen devices for users to interact with. Such devices may be incorporated with the systems discussed herein.

Computer system 700 may include a bus 710 or other communication mechanisms for communicating information data, signals, and information between various components of computer system 700. Components include an input/output (I/O) component 704 that processes a user action, such as selecting keys from a keypad/keyboard, selecting one or more buttons, links, actuatable elements, etc., and sending a corresponding signal to bus 710. I/O component 704 may also include an output component, such as a display 702 and a cursor control 708 (such as a keyboard, keypad, mouse, touchscreen, etc.). In some examples, I/O component 704 other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 718, which may be a micro-controller, digital signal processor (DSP), or other processing component, that processes these various signals, such as for display on computer system 700 or transmission to other devices over a network 726 via a communication link 724. Again, communication link 724 may be a wireless communication in some embodiments. Processor 718 may also control transmission of information, such as cookies, IP addresses, images, transaction information, learning model information, SQL support queries, and/or the like to other devices.

Components of computer system 700 also include a system memory component 712 (e.g., RAM), a static storage component 714 (e.g., ROM), and/or a disk drive 716. Computer system 700 performs specific operations by processor 718 and other components by executing one or more sequences of instructions contained in system memory component 712 (e.g., for engagement level determination). Logic may be encoded in a computer readable medium, which may refer to any medium that participates in providing instructions to processor 718 for execution. Such a medium may take many forms, including but not limited to, non-volatile media, volatile media, and/or transmission media. In various implementations, non-volatile media includes optical or magnetic disks, volatile media includes dynamic memory such as system memory component 712, and transmission media includes coaxial cables, copper wire, and fiber optics, including wires that comprise bus 710. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, hard disk, magnetic tape, any other magnetic medium, CD-ROM, any other optical medium, RAM, PROM, EPROM, FLASH-EPROM, any other memory chip or cartridge, or any other medium from which a computer is adapted to read.

Components of computer system 700 may also include a short range communications interface 720. Short range communications interface 720, in various embodiments, may include transceiver circuitry, an antenna, and/or waveguide. Short range communications interface 720 may use one or more short-range wireless communication technologies, protocols, and/or standards (e.g., WiFi, Bluetooth®, Bluetooth Low Energy (BLE), infrared, NFC, etc.).

Short range communications interface 720, in various embodiments, may be configured to detect other devices (e.g., user device, etc.) with short range communications technology near computer system 700. Short range communications interface 720 may create a communication area for detecting other devices with short range communication capabilities. When other devices with short range communications capabilities are placed in the communication area of short range communications interface 720, short range communications interface 720 may detect the other devices and exchange data with the other devices. Short range communications interface 720 may receive identifier data packets from the other devices when in sufficiently close proximity. The identifier data packets may include one or more identifiers, which may be operating system registry entries, cookies associated with an application, identifiers associated with hardware of the other device, and/or various other appropriate identifiers.

In some embodiments, short range communications interface 720 may identify a local area network using a short range communications protocol, such as WiFi, and join the local area network. In some examples, computer system 700 may discover and/or communicate with other devices that are a part of the local area network using short range communications interface 720. In some embodiments, short range communications interface 720 may further exchange data and information with the other devices that are communicatively coupled with short range communications interface 720.

In various embodiments of the present disclosure, execution of instruction sequences to practice the present disclosure may be performed by computer system 700. In various other embodiments of the present disclosure, a plurality of computer systems 700 coupled by communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link 724 and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on the user and user device, however, a customer, a merchant, a service or payment provider may otherwise presented with tailored information. Thus, “user” as used herein can also include charities, individuals, and any other entity or person receiving information. Having thus described embodiments of the present disclosure, persons of ordinary skill in the art will recognize that changes may be made in form and detail without departing from the scope of the present disclosure. Thus, the present disclosure is limited only by the claims.

what is claimed is:

1. A system comprising:
a non-transitory memory storing instructions; and
a processor configured to execute instructions to cause the system to:
in response to a determination that new data is available for processing, retrieve a data set associated with a user;
preprocess the data set, the preprocessing including formatting the data set for use in a machine learning model;
train the machine learning model using the data set;
translated the trained machine learning model into an SQL query; and
run, the SQL query in a server structure for making a prediction on the data set.

2. The system of claim 1, executing instructions further causes the system to:
train a decision tree to make a prediction using the formatted data set;
determine whether an error exists in the decision tree; and
in response to determining that an error exists, train another decision tree using the data set; and
generate an ensemble of decision trees to train the machine learning model.

3. The system of claim 2, wherein a graph is generated from the errors.

4. The system of claim 3, wherein the another decision tree is trained until the graph converges.

5. The system of claim 2, wherein the machine learning model is trained by the ensemble of decision trees generated from the data set.

6. The system of claim 1, wherein the SQL query is generated using a python library.

7. The system of claim 1, wherein the machine learning model is one of a gradient boosting model and a random forest model.

8. A method comprising:
in response to determining that new data is available for processing, retrieving a data set associated with a user;
preprocessing the data set, the preprocessing including formatting the data set for use in a machine learning model;
training the machine learning model using the data set;
translating the trained machine learning model into an SQL query; and
running, the SQL query in a server structure for making a prediction on the data set.

9. The method of claim 8, further comprising:
training a decision tree to make a prediction using the formatted data set;
determining whether an error exists in the decision tree; and
in response to determining that an error exists, training another decision tree using the data set; and
generating an ensemble of decision trees to train the machine learning model.

10. The method of claim 9, wherein a graph is generated from the errors.

11. The method of claim 10, wherein the another decision tree is trained until the graph converges.

12. The method of claim 9, wherein the machine learning model is trained by the ensemble of decision trees generated from the data set.

13. The method of claim 8, wherein the SQL query is generated using a python library.

14. The method of claim 8, wherein the machine learning model is one of a gradient boosting model and a random forest model.

15. A non-transitory machine readable medium having stored thereon machine readable instructions executable to cause a machine to perform operations comprising:
in response to determining that new data is available for processing, retrieving a data set associated with a user;
preprocessing the data set, the preprocessing including formatting the data set for use in a machine learning model;
training the machine learning model using the data set;
translating the trained machine learning model into an SQL query; and
running, the SQL query in a server structure for making a prediction on the data set.

16. The non-transitory medium of claim 15, further comprising:
training a decision tree to make a prediction using the formatted data set;
determining whether an error exists in the decision tree; and
in response to determining that an error exists, training another decision tree using the data set; and
generating an ensemble of decision trees to train the machine learning model.

17. The non-transitory medium of claim 16, wherein a graph is generated from the errors.

18. The non-transitory medium of claim 15, wherein the machine learning model is trained by the ensemble of decision trees generated from the data set.

19. The non-transitory medium of claim 15, wherein the SQL query is generated using a python library.

20. The method of claim 8, wherein the machine learning model is one of a gradient boosting model and a random forest model.
